(19) United States
(12) Patent Application Publication
(10) Pub. No.: US 2006/0188112 A1
(43) Pub. Date: Aug. 24, 2006

(54) Condenser microphone and method for manufacturing the same

(76) Inventors: Eekjoo Chung, Gimpo-si (KR); Sungho Park, Incheon-si (KR); Jun Lim, Seoul (KR)

Correspondence Address: CANTOR COLBURN, LLP, 55 GRIFFIN ROAD SOUTH, BLOOMFIELD, CT, 06002, US

(21) Appl. No.: 11/359,343

(22) Filed: Feb. 22, 2006

(30) Foreign Application Priority Data
Feb. 24, 2005 (KR) 10-2005-15377

(51) Int. Cl. H04R 25/00

(52) U.S. Cl. 381/174

(57) ABSTRACT

A condenser microphone in accordance with the present invention comprises a casing having an open end portion; a diaphragm inserted in the casing; a spacer inserted in the casing; a fixed electrode inserted in the casing; a first base consisting of a insulating material, the first base being inserted in the casing; a second base consisting of a conductive material, the second base being inserted in the casing; and a PCB welded to the end portion of the casing, the PCB having a circuit component mounted thereon, and including a connection terminal for an external connection formed thereon.

### FIELD OF THE INVENTION

The present invention relates to a condenser microphone, and in particular, a condenser microphone and a method for manufacturing the same wherein a casing and a PCB are bonded by a welding.

### BACKGROUND OF THE INVENTION

FIG. 1 is cross-sectional view schematically illustrating a typical condenser microphone.

The typical condenser microphone 10 comprises a metal casing 11 having a cylinder shape and having an acoustic hole 11a disposed on a front plate thereof, a polar ring 12 consisting of a conductive material, a vibrating plate 13, a spacer 14, a ring-shaped first base 15 (alternately referred to as an “insulation base”) consisting of an insulating material, a fixed electrode 16 opposing the vibrating plate 13 and having the spacer 14 therebetween, a second base 17 (alternately referred to as an “conductive base”) consisting of a conductive material, and a PCB 18 having a circuit component and a connection terminal disposed thereon. The condenser microphone 10 is manufactured by sequentially stacking the components and curling (11b) an end of the casing 11. The polar ring 12 and the vibrating plate 13 are bonded together as a single body, and the fixed electrode 16 has a structure wherein a high molecular film is coated on metal plate to form an electret in case of an electret type microphone.

However, the conventional curling process wherein one end of the casing 11 is curled toward the PCB 18 is disadvantageous in that a pressure during the process and a margin of the components have an effect on a shape or an acoustic characteristic of a final product. That is, when the pressure is not sufficient during the curling process, an acoustic pressure may leak into a gap between the casing and the PCB. In this case, a defective product is manufacture due to a distortion of the acoustic characteristic, or the product does not operate due to an electrical cutting of a wire. In addition, when the pressure is excessive during the curling process, a curled surface may be ripped or the internal component is deformed, resulting in the distortion of the acoustic characteristic.

### DETAILED DESCRIPTION OF THE INVENTION

It is an object of the present invention to provide a condenser microphone and a method for manufacturing the same wherein a curling process which is for bonding the metal casing and the PCB is eliminated and an end portion of the casing having components for the condenser microphone enclosed therein is welded to the PCB to be bonded for improving bond strength.

In order to achieve the above object of the invention, there is provided a condenser microphone comprising: a casing having an open end portion; a diaphragm inserted in the casing; a spacer inserted in the casing; a fixed electrode inserted in the casing; a first base consisting of a insulating material, the first base being inserted in the casing; a second base consisting of a conductive material, the second base being inserted in the casing; and a PCB welded to the end portion of the casing, the PCB having a circuit component mounted thereon, and including a connection terminal for an external connection formed thereon.

It is preferable that the casing is cylinder-shaped or rectangular-shaped, the end portion of the casing is straight or bent outward, the PCB is equal to or larger than the casing, and a conductive pattern is disposed on a portion where the PCB is welded to the casing. In addition, the second base comprises a spring structure having an elasticity.

In order to achieve the above object of the invention, there is provided a method for manufacturing a condenser microphone, comprising the steps of: (a) inserting a diaphragm, a spacer, a fixed electrode, a first base consisting of an insulating material, and a second base consisting of a conductive material into a casing having a first end open; and (b) welding an end of the casing to a PCB after performing the step (a).

It is preferable that the casing is cylinder-shaped or rectangular-shaped, the end portion of the casing is straight or bent outward, the PCB is equal to or larger than the casing, and a conductive pattern is disposed on a portion where the PCB is in contact with the casing. In addition, the welding the end of the casing is selected from a group consisting of an electric welding, a soldering, and a use of an adhesive.

As described above, in accordance with the present invention, a curling process which is for bonding the metal casing and the PCB is eliminated and an the casing having components for the condenser microphone enclosed therein is welded to the PCB to be bonded for improving bond strength, thereby improving an electrical conductibility between the casing and the PCB as well as improving a sealing so that the acoustic pressure does not enter from outside to enhance the acoustic characteristic.

In addition, a shape of the PCB is not limited by the casing so that the PCB used in the microphone may be freely designed to allow a terminal having various forms. Moreover, a manufacturing is possible without using a physical force which is applied during the conventional curling process. Therefore, a very thin PCB may be applied and a slim microphone having a small height may be manufactured when the thin PCB is used.

### BRIEF DESCRIPTION OF THE DRAWINGS

FIG. 1 is cross-sectional view illustrating a typical condenser microphone.

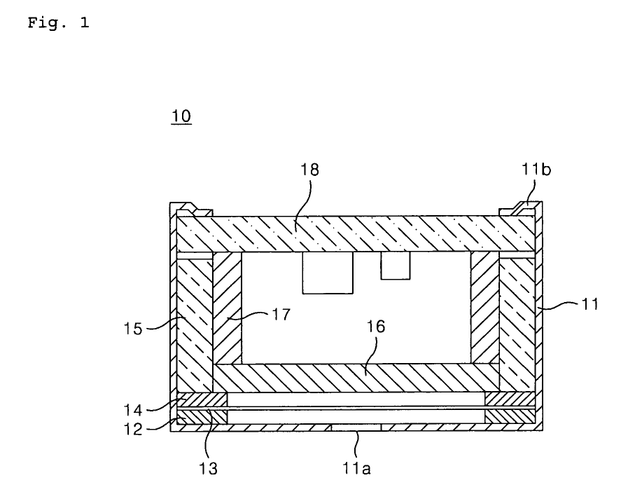

FIG. 2 is a cross-sectional view illustrating a condenser microphone in accordance with a first embodiment of the present invention.

FIG. 3 is a cross-sectional view illustrating a condenser microphone in accordance with a second embodiment of the present invention.

FIG. 4 is a cross-sectional view illustrating a condenser microphone in accordance with a third embodiment of the present invention.

FIG. 5 is a cross-sectional view illustrating a condenser microphone in accordance with a fourth embodiment of the present invention.

FIG. 6 is a cross-sectional view illustrating a condenser microphone in accordance with a fifth embodiment of the present invention.

### PREFERRED EMBODIMENTS

The above-described objects and other objects and characteristics and advantages of the present invention will now be described in detail with reference to the accompanied drawings.

The present invention is characterized in that a casing and a PCB are directly welded for bonding without performing a conventional curling for bonding the casing and the PCB by curling an end of the casing after stacking components in the casing during a condenser microphone assembly process. There are various methods for directly bonding the casing to the PCB. The present invention will be described below by exemplifying a first embodiment wherein a casing having a straight end is welded to a PCB larger than the casing, a second embodiment wherein a casing having an end bent outward is welded to a PCB larger than the casing, a third embodiment wherein a spring structure is applied to a conductive base, a fourth embodiment wherein a casing is welded to a PCB in a microphone integrated to the PCB such as a silicon type condenser microphone, and a fifth embodiment wherein a casing having a straight end is welded to a PCB enclosed in the casing.

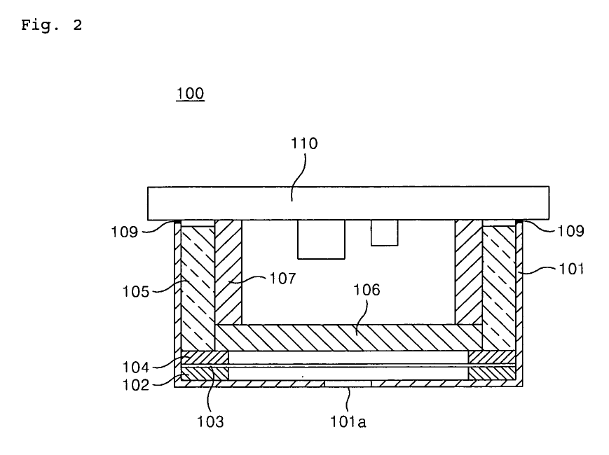

FIG. 2 is a cross-sectional view illustrating a condenser microphone in accordance with a first embodiment of the present invention wherein a casing having a straight end is welded to a PCB larger than the casing.

Referring to FIG. 2, the condenser microphone 100 of the present invention, as shown in FIG. 2, is manufactured by stacking a polar ring 102 consisting of a conductive material, a vibrating plate 103, a spacer 104, a first base 105 consisting of an insulating material, a fixed electrode 106 opposing the vibrating plate 103 and having the spacer 104 therebetween, and a second base 107 consisting of a conductive material in a metal casing 101 consisting of a metallic material and having an acoustic hole 101a disposed on a front plate thereof wherein one end of the casing 101 is a straight type, and then welding the one end of the casing 101 to a PCB 110. The polar ring 102 and the vibrating plate 103 may be a single body, and the fixed electrode 106 has a structure wherein a high molecular film is coated on metal plate to form an electret in case of an electret type microphone. The welding method of the casing 101 to the PCB 110 may be a laser welding, electric welding, a soldering or a use of a conductive adhesive.

In addition, since the PCB 110 is not required to be enclosed by the casing 101, the PCB 110 may be larger than the casing 101, and a conductive pattern is formed on a PCB surface 109 which is in contact with the casing 101 for facilitating the bonding. The PCB 110 is bonded to the casing 101 so that a component mounted on the PCB 110 faces a space inside the second base 107, a connection pad or a connection terminal (not shown) for bonding to a main board of a product which uses the microphone is formed on an exposed portion of the PCB 110. Since a size of the PCB is not limited to the casing of the microphone, the connection pad or the connection terminal for connection to the main board may be arranged freely on a large PCB. For example, when the connection terminal is formed on the protruded PCB surface rather than case 101, the PCB 110 can be mounted or demounted on the main board (not shown) through directly heating with an electric soldering iron.

Particularly, since the present invention does not require the curling process, microphones having various shapes may be manufactured by welding the casing having a rectangular pillar structure or other casing having angled structure which are difficult to be welded as well as a cylinder-shaped casing to the PCB surface, and a shape of a welding portion of the casing may also be modified to rectangular or bent “ [symbol] ” shape. In addition, it is preferable that the welding portion 109 of the PCB is manufactured by coating a copper film through a general PCB manufacturing process, and electroplating nickel or gold.

As described above, an electrical conductibility between the casing 101 and the PCB 110 is improved by welding the end of the casing 101 to the PCB 110 as well as a sealing so that the acoustic pressure does not enter from outside to enhance the acoustic characteristic.

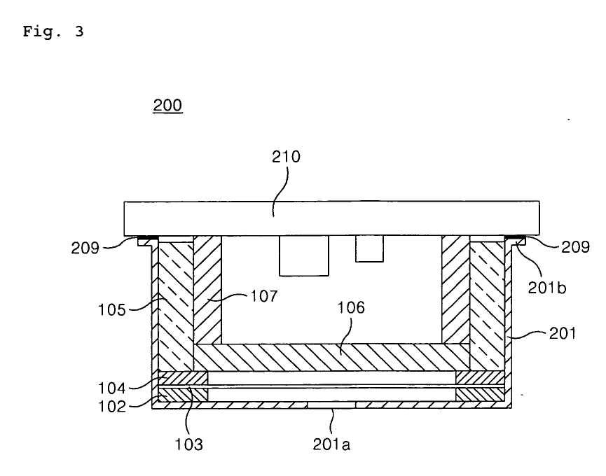

FIG. 3 is a cross-sectional view illustrating a condenser microphone in accordance with the second embodiment of the present invention wherein a casing having an end bent outward is welded to a PCB larger than the casing.

Referring to FIG. 3, a condenser microphone 200 of the present invention, as shown in FIG. 3, is manufactured by stacking a polar ring 102 consisting of a conductive material, a vibrating plate 103, a spacer 104, a first base 105 consisting of an insulating material, a fixed electrode 106 opposing the vibrating plate 103 and having the spacer 104 therebetween, and a second base 107 consisting of a conductive material in a metal casing 201 consisting of a metallic material and having an acoustic hole 201a disposed on a front plate thereof wherein one end 201b of the casing 201 is bent outward, and then welding the one end 201b of the casing 201 to a PCB 210. The polar ring 102 and the vibrating plate 103 may be a single body, and the fixed electrode 106 has a structure wherein a high molecular film is coated on metal plate to form an electret in case of an electret type microphone. The welding method of the casing 201 to the PCB 210 may be a laser welding, electric welding, a soldering or a use of a conductive adhesive.

In addition, since the PCB 210 is not required to be enclosed by the casing 201, the PCB 210 may be larger than the casing 201, and a conductive pattern is formed on a PCB surface 209 which is in contact with the casing 201 for facilitating the bonding. The PCB 210 is bonded to the casing 201 so that a component mounted on the PCB 210 faces a space inside the second base 107, a connection pad or a connection terminal (not shown) for bonding to a main board of a product which uses the microphone is formed on an exposed portion of the PCB 110. Since a size of the PCB is not limited to the casing of the microphone, the connection pad or the connection terminal for connection to the main board may be arranged freely on a large PCB. For example, when the connection terminal is formed the PCB surface extruding above the casing 201, the PCB 210 may be directly heated using an electric soldering iron to mount on or unmount from the PCB.

Particularly, since the present invention does not require the curling process, microphones having various shapes may be manufactured by welding the casing having a rectangular pillar structure or casings having other structure which are difficult to be welded as well as a cylinder-shaped casing to the PCB surface, and a shape of a welding portion of the casing is bent to have “ [symbol] ” shape to facilitate the welding. In addition, it is preferable that the welding portion 209 of the PCB is manufactured by coating a copper film through a general PCB manufacturing process, and electroplating nickel or gold.

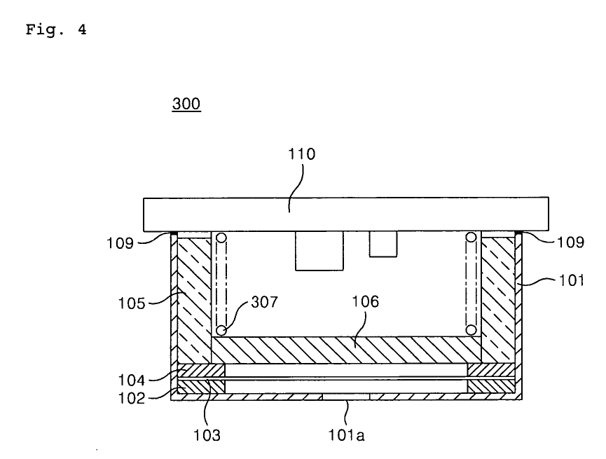

FIG. 4 is a cross-sectional view illustrating a condenser microphone in accordance with a third embodiment of the present invention wherein a spring structure is applied to a conductive base.

Referring to FIG. 4, a condenser microphone 300 of the present invention, as shown in FIG. 4, is manufactured by stacking a polar ring 102 consisting of a conductive material, a vibrating plate 103, a spacer 104, a first base 105 consisting of an insulating material, a fixed electrode 106 opposing the vibrating plate 103 and having the spacer 104 therebetween, and a second base 307 comprising a metallic spring in a metal casing 101 consisting of a metallic material and having an acoustic hole 101a disposed on a front plate thereof wherein one end of the casing 101 is a straight type, and then welding the one end of the casing 101 to a PCB 110. Although not shown, a structure employing the spring type second base 307 may be similarly applied to the second embodiment.

As described above, an electrical conductibility between the casing 101 and the PCB 110 is improved by welding the end of the casing 101 to the PCB 110 as well as a sealing so that the acoustic pressure does not enter from outside to enhance the acoustic characteristic. In addition, when the spring type second base 307 is employed in accordance with the third embodiment, the components are adhered to a bottom of the casing by an elasticity of the second base 307, thereby supporting the components more firmly and improving the electrical conductibility.

A structure of the third embodiment is identical to the first embodiment except that a spring structure is employed to the second base 307. Therefore, a description in detail is omitted.

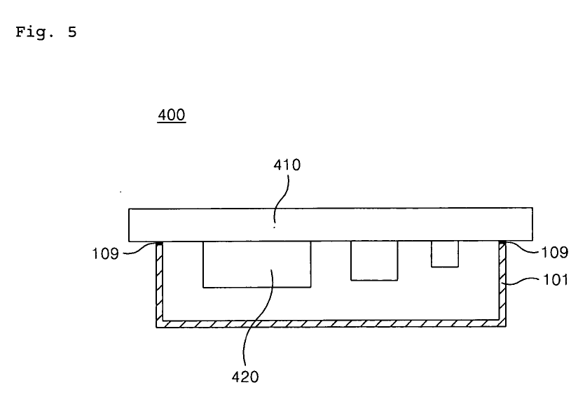

FIG. 5 is a cross-sectional view illustrating a condenser microphone in accordance with a fourth embodiment of the present invention wherein a casing is welded to a PCB in a microphone integrated to the PCB such as a silicon type condenser microphone.

Referring to FIG. 5, a microphone 400 of the present invention is manufactured by welding a casing 101 having a straight type end portion to a PCB 410 larger than the casing 101 wherein the PCB 410 has a silicon type microphone 420 which is formed by integrating a diaphragm, a spacer and a fixed electrode on the PCB. Although not shown, the fourth embodiment may be applied to the casing having an end bent to have a shape of “ [symbol] ” similar to the second embodiment.

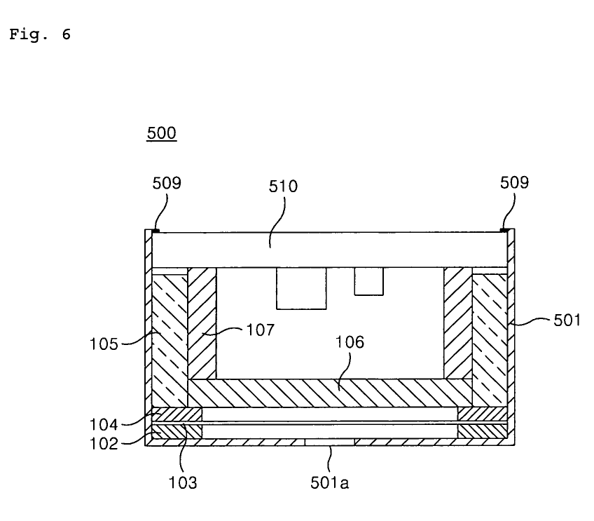

FIG. 6 is a cross-sectional view illustrating a condenser microphone in accordance with a fifth embodiment of the present invention wherein a casing having a straight end is welded to a PCB enclosed in the casing.

Referring to FIG. 6, a condenser microphone 500 of the present invention, as shown in FIG. 6, is manufactured by stacking a polar ring 102 consisting of a conductive material, a vibrating plate 103, a spacer 104, a first base 105 consisting of an insulating material, a fixed electrode 106 opposing the vibrating plate 103 and having the spacer 104 therebetween, a second base 107 consisting of a conductive material, and a PCB 510 having components mounted thereon in a metal casing 501 consisting of a metallic material and having an acoustic hole 501a disposed on a front plate thereof wherein one end of the casing 501 is a straight type, and then welding the one end of the casing 501 to a PCB 510. A conductive pattern is formed on a PCB surface 509 where the casing 501 contacts the PCB 510. The PCB 510 is bonded to the casing 501 so that a component mounted on the PCB 510 faces a space inside the second base 107, a connection pad or a connection terminal (not shown) for bonding to a main board of a product which uses the microphone is formed on an exposed portion of the PCB 510.

Since the present invention does not require the curling process, microphones having various shapes may be manufactured by welding the casing having a rectangular pillar structure or casings having other structures which are difficult to be welded as well as a cylinder-shaped casing to the PCB surface, and a shape of a welding portion of the casing may also be modified to rectangular or bent “ [symbol] ” shape. In addition, it is preferable that the welding portion 109 of the PCB is manufactured by coating a copper film through a general PCB manufacturing process, and electroplating nickel or gold.

As described above, an electrical conductibility between the casing 501 and the PCB 510 is improved by welding the end of the casing 501 to the PCB 510 as well as a sealing so that the acoustic pressure does not enter from outside to enhance the acoustic characteristic.

The above embodiment only illustrated the structure which a diaphragm is located in front of a fixed electrode at the bottom of a casing. However, it can be similarly applied to a microphone or a directivity microphone of another structure which the fixed electrode is located in front of the diaphragm at the bottom of the casing.

### INDUSTRIAL APPLICABILITY

A condenser microphone and a method for manufacturing the same wherein a curling process which is for bonding the metal casing and the PCB is eliminated and an end portion of the casing having components for the condenser microphone enclosed therein is welded to the PCB to be bonded for improving bond strength is provided.

What is claimed is:

1. A condenser microphone comprising:
a casing having an open end portion;
a diaphragm inserted in the casing;
a spacer inserted in the casing;
a fixed electrode inserted in the casing;
a first base consisting of a insulating material, the first base being inserted in the casing;
a second base consisting of a conductive material, the second base being inserted in the casing; and
a PCB welded to the end portion of the casing, the PCB having a circuit component mounted thereon, and including a connection terminal for an external connection formed thereon.

2. The condenser microphone in accordance with claim 1, wherein the casing is cylinder-shaped or rectangular-shaped.

3. The condenser microphone in accordance with claim 2, wherein the end portion of the casing is straight or bent outward.

4. The condenser microphone in accordance with claim 1, wherein the PCB is equal to or larger than the casing, and a conductive pattern is disposed on a portion where the PCB is welded to the casing

5. The condenser microphone in accordance with claim 1, wherein the second base comprises a spring structure having an elasticity.

6. A method for manufacturing a condenser microphone, comprising the steps of:
(a) inserting a diaphragm, a spacer, a fixed electrode, a first base consisting of an insulating material, and a second base consisting of a conductive material into a casing having a first end open; and
(b) welding an end of the casing to a PCB after performing the step (a).

7. The method in accordance with claim 6, wherein the casing is cylinder-shaped or rectangular-shaped.

8. The method in accordance with claim 7, wherein the end portion of the casing is straight or bent outward.

9. The method in accordance with claim 6, wherein the PCB is equal to or larger than the casing, and a conductive pattern is disposed on a portion where the PCB is in contact with the casing

10. The method in accordance with claim 6, wherein the welding the end of the casing is selected from a group consisting of an electric welding, a soldering, and a use of an adhesive.
